(19) United States
(12) Patent Application Publication
(10) Pub. No.: US 2026/0054937 A1
(43) Pub. Date: Feb. 26, 2026

(54) Long Stroke Rocker Leg

(71) Applicant: General Kinematics Corporation, Crystal Lake, IL (US)

(72) Inventor: Edward Steffes, Jr., Woodstock, IL (US)

(21) Appl. No.: 19/307,846

(22) Filed: Aug. 22, 2025

Related U.S. Application Data
(60) Provisional application No. 63/686,135, filed on Aug. 22, 2024.

(51) Int. Cl. B65G 27/04; B32B 25/04; B65G 27/12

(52) U.S. Cl. CPC B65G 27/04; B65G 27/12; B32B 25/042; B32B 2250/02; B32B 2250/248; B65G 2812/12

(57) ABSTRACT

A rocker leg configured for a vibratory apparatus includes a rocker leg body having a first end and a second end, each of the first end and the second end having a passage therethrough. A first bushing is disposed in the passage through the first end of the rocker leg body, and a second bushing is disposed in the passage through the second end of the rocker leg body. Each of the first and second bushings include an inner sleeve, an intermediate ring, an outer sleeve, a first layer of resilient material between the inner sleeve and the intermediate ring, and a second layer of resilient material between the intermediate ring and the outer sleeve. Also provided is a vibratory apparatus with a deck, at least one pair of such a rocker leg and a resilient member supporting the deck, and an eccentric drive coupled to the deck.

This patent application claims the benefit of U.S. Provisional Patent Application No. 63/686,135, filed Aug. 22, 2024, which application is hereby incorporated herein by reference.

### BACKGROUND

This patent is directed to a rocker leg configured for a vibratory apparatus and having long stroke capability, and to a vibratory apparatus including a rocker leg having long stroke capability.

Certain vibratory apparatuses are constructed with a deck supported on or suspended over a surface by a plurality of pairs of rocker legs and resilient members, such as coil springs. The deck is coupled to an eccentric drive which causes the deck to move in such a fashion that, for example, material travels along the deck in a series of gentile throws and catches.

In such apparatuses, it has been found that longer strokes are possible as a consequence of developments in resilient member technology. On the other hand, the same longer strokes may have a detrimental effect on conventional rocker legs. The longer strokes possible with newer springs result in increased wear of the rocker legs, particularly in the bushings found in conventional rocker legs.

It would be advantageous to overcome or substantially ameliorate one or more of the disadvantages of existing rocker legs and of existing vibratory apparatuses with a new rocker leg of novel and inventive design and a vibratory apparatus including such a rocker leg, or at least to provide a useful alternative.

### SUMMARY

According to one aspect of the present disclosure, a rocker leg is configured for a vibratory apparatus, the rocker leg including a rocker leg body having a first end and a second end, each of the first end and the second end having a passage therethrough, and a first bushing and a second bushing, the first bushing disposed in the passage through the first end of the rocker leg body and the second bushing disposed in the passage through the second end of the rocker leg body. Each of the first and second bushings include an inner sleeve, an intermediate ring, and an outer sleeve, and each of the first and second bushings include a first layer of resilient material between the inner sleeve and the intermediate ring, and a second layer of resilient material between the intermediate ring and the outer sleeve.

According to another aspect of the present disclosure, a vibratory apparatus includes a deck, at least one pair of a rocker leg and a resilient member supporting the deck, and an eccentric drive coupled to the deck. The rocker leg includes a rocker leg body having a first end and a second end, each of the first end and the second end having a passage therethrough, and a first bushing and a second bushing, the first bushing disposed in the passage through the first end of the rocker leg body and the second bushing disposed in the passage through the second end of the rocker leg body. Each of the first and second bushings include an inner sleeve, an intermediate ring, and an outer sleeve, and each of the first and second bushings include a first layer of resilient material between the inner sleeve and the intermediate ring, and a second layer of resilient material between the intermediate ring and the outer sleeve.

### BRIEF DESCRIPTION OF THE DRAWINGS

It is believed that the disclosure will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings is necessarily to scale.

FIG. 1 is a side view of an embodiment of a vibratory apparatus;

FIG. 2 is a side view of an embodiment of a link or rocker leg according to an embodiment of the vibratory apparatus;

FIG. 3 is a perspective view of an embodiment of a spring assembly or resilient member that may be used with the embodiments of a vibratory apparatus disclosed herein;

FIG. 4 is an enlarged, perspective view of a distal portion of an end shank of the embodiment of a spring assembly of FIG. 3;

FIG. 5 is a perspective view of another embodiment of a vibratory apparatus;

FIG. 6 is an end view of the vibratory apparatus of FIG. 5;

FIG. 7 is an end view of a further embodiment of a vibratory apparatus; and

FIG. 8 is an end view of a still further embodiment of a vibratory apparatus.

### DETAILED DESCRIPTION OF VARIOUS EMBODIMENTS

While the present disclosure describes a rocker leg that accommodates long strokes with what is believed to be improved performance characteristics, such as operational life, the combination of such a rocker leg with other structures to form a vibratory apparatus is discussed first. It is believed that this context is important to better understand the rocker leg structure and operation, particularly for those unfamiliar with vibratory apparatuses. Having discussed the apparatus as a whole, the details of the apparatus and its variants are then discussed, starting with the rocker leg.

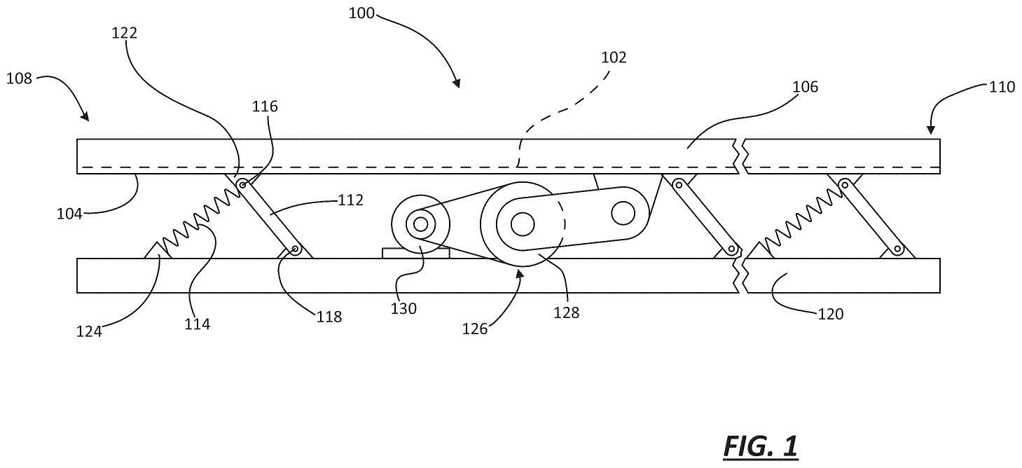

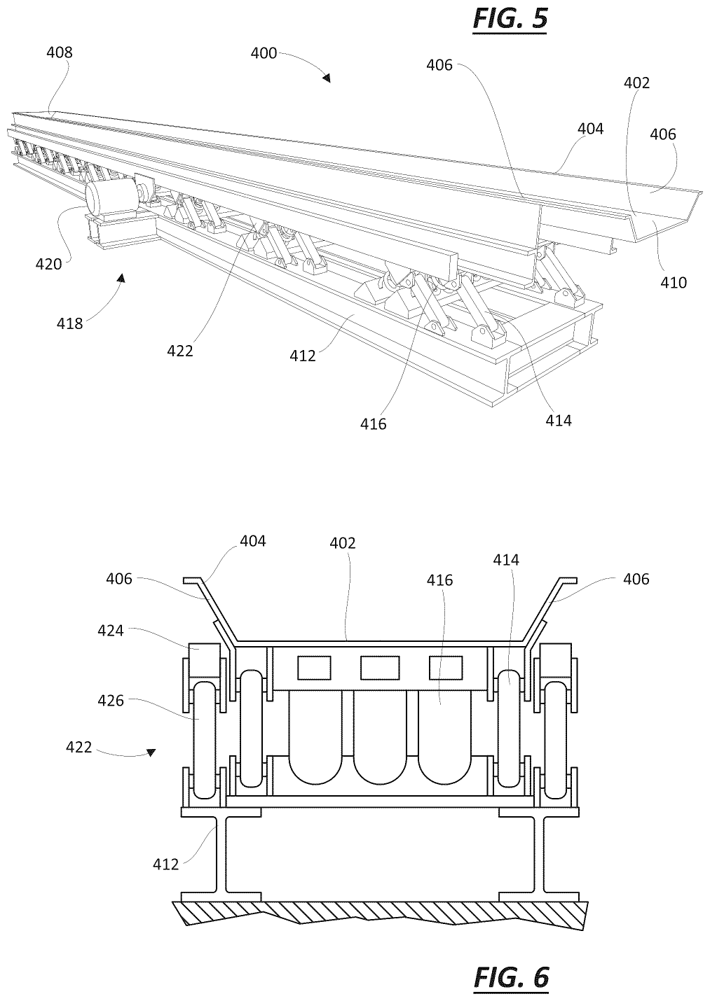

A vibratory apparatus 100 according to an embodiment of the present disclosure is illustrated in FIG. 1. While an embodiment of the vibratory apparatus 100 is illustrated in FIG. 1 the vibratory apparatus of the present disclosure is not limited to this single embodiment. A wide range of variants are described in FIGS. 5-8.

The apparatus 100 may include a deck 102. As illustrated, the deck 102 may be part of a trough 104. The trough 104 includes the deck 102 and one or more sidewalls 106. In FIG. 1, the trough 104 includes two opposing sidewalls 106 disposed on either side of the deck 102, the foremost of which is visible in FIG. 1.

According to certain embodiments, the deck 102 may have a solid surface, i.e., one that does not have openings, holes, or passages therethrough. As such, materials move along and across the deck 102 from a first end 108 to a second end 110. According to other embodiments, the deck 102 may have a perforated surface, i.e., one that has openings, holes, or passages therethrough. As such, as materials move along the deck 102, the materials (or a fraction thereof) can move across the deck from a first end 108 to a second end 110 or through the deck 102 from above the deck 102 to below the deck 102. As a further alternative, air, for example, may be passed through a perforated deck 102 to mix with the materials moving along and across the deck 102.

The trough 104, and particularly the deck 102, is supported above a surface. The trough 104 may be supported above the surface by suspending the trough 104 from a structure disposed above the trough 104, or by supporting the trough 104 from below the trough 104. As illustrated, the trough 104 is supported by a plurality of pairs of links or rocker legs 112 and resilient members 114 disposed below the trough 104.

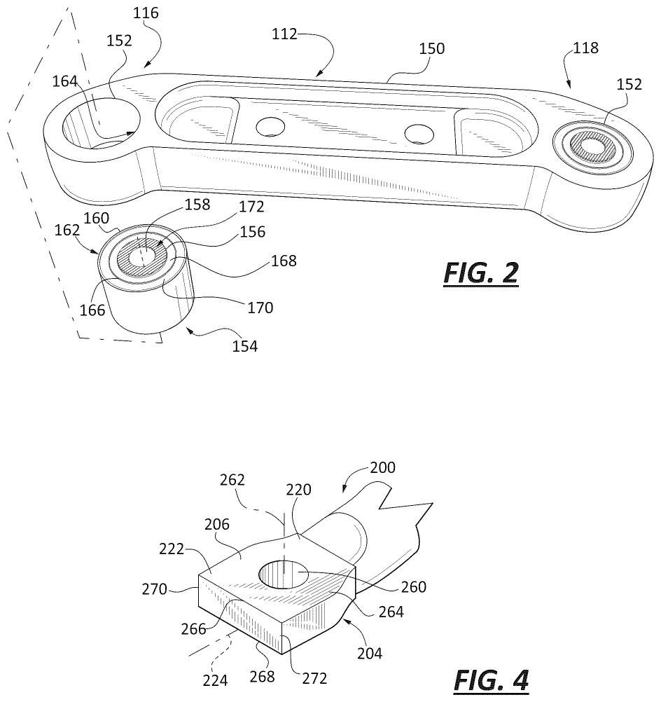

The rocker legs 112 are illustrated in FIG. 2. The rocker legs 112 may be attached at a first end 116 to the trough 104 and at a second end 118 to the surface (which may be referred to as “ground” although it may be a second story of a multi-story building, for example), often via a support structure or base 120 that may be supported on the surface. The rocker legs 112 may have bushings, as described in detail below, at ends 116, 118 that accommodate long strokes. The details of the rocker legs 112 are discussed below.

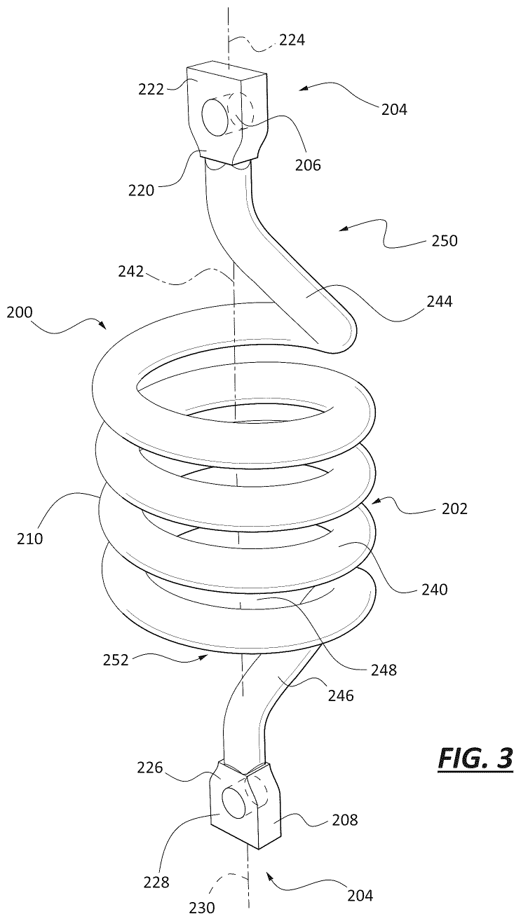

The resilient members 114 may be as illustrated in FIGS. 3 and 4. The discussion of the resilient members 114 in the context of the structure illustrated in FIGS. 3 and 4 is not intended to limit the resilient members 114 only to such structures. Indeed, conventional coil springs may be used, such as illustrated in U.S. Pat. Nos. 4,171,948 and 4,844,235, for example. Still, the resilient members 114 illustrated in FIGS. 3 and 4 may be combined with the rocker legs 112 illustrated in FIG. 2 to provide a vibratory apparatus with improved stroke length. Like the rocker legs, the resilient members 114 may be attached at a first end 122 to the trough 104 and at a second end 124 to the support structure 120 that may be supported on the surface. The resilient members 114 may be disposed to make a substantially right angle with the rocker legs 112. The details of the resilient members 114 are discussed below.

The trough 104 may include other features as well. For example, the trough may include a floor beneath the deck 102. As such, materials passing through a perforated deck 102 may be deposited on the floor and move along the floor. Alternatively, the sidewalls 106, the floor and end walls (at ends 108, 110) may define a plenum below a perforated deck 102 for the introduction of air, for example, through the deck 102 into the materials moving across the deck 102. As a further alternative, the floor may be omitted, and there may be an opening beneath the deck 102. As a further alternative, a hood may be disposed over the deck 102 in combination with any of the other embodiments for the deck 102/floor described above.

An exciter 126 may be coupled to the deck 102, for example via the attachment of the exciter(s) 126 to the through 104. The exciter 126 may include an eccentric drive 128 including a shaft to which at least one (one or more) eccentric mass(es) (or weight(s)) are attached. The exciter 124 may also include a motor 130 that is coupled to the eccentric drive; alternative the shaft of the motor may also serve as the shaft of the eccentric drive and have the eccentric masses attached thereto. Material moves in a series of throws and catches because of the controlled motion produced by the eccentric drive 128 and the links 112. The resilient members 114 are designed to match the resonant frequency of the eccentric drive.

Having thus described the apparatus 100 to provide better context, the rocker leg 112 according to the present disclosure is now described in detail with reference to FIG. 2. As noted, the rocker leg 112 has first ends 116, 118, although considering the symmetry of the rocker leg 112, the drawing could easily be reversed with first end 118 at the left-hand side and the second end 116 at the right-hand side.

The rocker leg 112 includes a body 150 which may be made of a metal, such as steel or aluminum. The body 150 has openings or passages 152 formed at the ends 116, 118, each passage 152 may accommodate a bushing 154, which bushing 154 may be press fit into the passage 152 for example. The rocker leg 112 is connected to the vibratory apparatus 100 via the bushing 154; for example, a fastener such as a bolt (e.g., a ¾ inch (1.91 cm) bolt) may be passed through the bushing 154 to form a pivotal connection or mount between the rocker leg 112 and a bracket of the vibratory apparatus 100.

The bushing 154 itself includes an innermost journal 156, which may also be referred to as a first or inner sleeve. The journal 156, which may be made of metal (such as hardened steel), has an annular shape with a passage 158 through which the fastener (e.g., bolt) may be disposed to connect the rocker leg 112 to the vibratory apparatus 100. The bushing 154 also includes a second or outer sleeve 160, which also be made of metal and have an annular shape like the inner sleeve 156. An outer surface 162 of the outer sleeve 160 abuts an inner surface 164 of the passage 152 when the bushing is disposed within the passage 152.

Disposed between the inner sleeve 156 and the outer sleeve 160 is an intermediate annular structure, or ring, 166. Between the inner sleeve 156 and the intermediate ring 166 and between the outer sleeve 160 and the intermediate ring 166 is disposed a resilient material such as an elastomer, which elastomer may include natural and synthetic materials; examples include natural or synthetic rubbers and rubber blends. That is, a first layer of resilient material 168 is disposed between an outer surface of the inner sleeve 156 and a facing inner surface of the intermediate ring 166, and a second layer of resilient material 170 is disposed between an outer surface of the intermediate ring 166 and a facing inner surface of the outer sleeve 160. During manufacturing, the resilient material 168, 170 may be installed in a manner where the material 168, 170 is precompressed to accommodate stretch during operation, which feature may contribute to the ability for the rocker leg 112 to accommodate long strokes.

While the bushing 154 has been illustrated with the inner sleeve 156, intermediate ring 166, and outer sleeve 160 as concentric and with equal thicknesses (in a radial direction) of elastomer between the sleeve 156, ring 166, and sleeve 160, this is not required in all embodiments. For example, the thickness of the elastomer layer 168 may be smaller or larger than the thickness of the elastomer layer 170. It is believed that different thickness will provide different performance characteristics for the bearing 154, and thus the rocker leg 112.

It is further believed that use of the bushings 154 in a rocker leg 112 of a vibratory apparatus will improve the stroke length, which in turn will allow for better separation of the material moving along the deck 102 (in those embodiments where separation is relevant) and faster travel speeds for the material moving along the deck 102. Indeed, it is believed that using the bushings 154 in a rocker leg will permit the rocker leg to pivot up to (and even in excess of) ±15 degrees, ±18 degrees, or ±20 degrees from the leg's initial orientation. Such an angular pivot is believed to be double the angular pivot possible with traditional or conventional bushings. As one example, for a rocker leg 112 having a length of 14 inches (35.56 cm) between the ends 116, 118, the leg 112 could accommodate a stroke length in excess of 1.875 inches (4.76 cm).

To permit the leg 112 to be securely fastened or attached at the ends 116, 118, the first or inner sleeve 156 may have a texture or pattern applied to front and rear surfaces. A front surface 172 of the sleeve 156 is visible in FIG. 2, and the rear surface would be opposite the front surface 172. The texture applied to the surfaces may be a knurled pattern, such as a linear knurled pattern as illustrated. The texture or pattern may be regularly repeated or may be irregular. It is believed that the knurled pattern will permit the bolt or other fastener passed through the sleeve 156 to grip the sleeve 156 better than if the surface 172 was smooth (i.e., unpatterned or untextured). Like the press-fit between the bushing 154 and the body 150 of the leg 112, the grip between the fastener and the sleeve 156 is important to the pivoting action of the leg 112 by providing a secure connection between the leg 112 and the structure to which it is attached.

A spring assembly, or resilient member, 200 according to one or more embodiments of the present disclosure is illustrated in FIGS. 3 and 4. Such a spring assembly or resilient member 200 may be used as the resilient members 114 in the embodiment of the vibratory apparatus 100 above, or in the embodiments of the vibratory apparatus 400 below. This does not limit the vibratory apparatuses 100, 400 to such a spring assembly 200, although such a spring assembly may provide potentially longer strokes than the conventional coil spring such as is illustrated in U.S. Pat. Nos. 4,171,948 and 4,844,235, for example, and thus may be advantageously combined with the link or rocker leg described above.

In this embodiment, a spring assembly includes a resilient member 202 having multiple attachment sites (at least two) 204. See FIG. 3. The resilient member 202 has a first end shank 206, a second end shank 208, and a central helical portion 210. The attachment sites 204 are disposed at each of the first end shank 206 and the second end shank 208.

The first end shank 206 extends in a first direction from the central helical portion 210 from a proximal end 220 to a distal end 222. The first end shank 206 has a longitudinal axis 224 from the proximal end 220 to the distal end 222.

The second end shank 208 extends in a second direction from the central helical portion 210 from a proximal end 226 to a distal end 228. The second end shank 208 has a longitudinal axis 230 from the proximal end 226 to the distal end 228. The second direction is opposite the first direction.

The central helical portion 210 including one or more coils 240 disposed about a central longitudinal axis 242. In addition, the central helical portion 210 has a first end 244 attached to the proximal end 220 of the first end shank 206 and a second end 246 attached to the proximal end 226 of the second end shank 208. Further, the longitudinal axis 224 of the first shank end 206, the longitudinal axis 230 of the second shank end 208, and the central longitudinal axis 242 of the central helical portion 210 are parallel to each other or are collinear (as illustrated).

The coils 240 may be spaced apart such that there are spaces 248 between coils 240 that are adjacent each other in a longitudinal direction (e.g., one above the other). Further, the coils 240 may have a curved transition 250, 252 at the first and second ends 244, 246 that attach to the first and second end shanks 206, 208, rather than an abrupt turn or bend in the coil at the first and second ends 244, 246 of the central helical portion 210. While the curved transition 250, 252 has been illustrated, other transitions are possible.

While the end shanks 206, 208 and the central helical portion 210 may comprise separate structural elements that are attached by welding, for example, the end shanks 206, 208 and the central helical portion 210 instead may be formed such that the structure of the end shanks 206, 208 and central helical portion 210 is an integral (i.e., one-piece) structure. In an integral structure, it is still proper to refer to the end shanks 206, 208 as being attached at the ends 244, 246 of the central helical portion 210, even if a joining method, such as welding, is not used to form the attachment.

The attachment site 204 is used to secure the spring assembly 200 to a vibratory apparatus. According to the illustrated embodiments, the attachment site 204 attaches the first and second end shanks 206, 208 of the spring assembly 200 to the vibratory apparatus, for example, using fasteners (e.g., nut and bolt pairs, rivets, etc.) where the axis of the fastener (e.g., the bolt) is transverse to the axes 224, 230 of the end shanks 206, 208 and the central axis 242 of the helical portion 210. An attachment site that permits the fastener to be so arranged may be referred to herein as a transverse attachment site. Such a transverse arrangement may provide one or more advantages, including a perpendicular loading of the fastener (as compared to an axial loading).

As illustrated in greater detail in FIG. 4, the end shanks (and in particular the distal end 222 of the end shank 206, as illustrated) have a hole 260 extending or depending therethrough, the hole 260 having an axis 262 that is transverse to a longitudinal axis 224 of the end shank 206. As such, if the end shank 206 were to be secured to a structure, the fastener passing through the hole 224 in the end shank 206 would be transverse to the end shank 206.

Thus, in more general terms, the embodiment of the spring assembly 200 of FIG. 4 has at least one of a first end shank and a second end shank with a hole formed therethrough. The hole has an axis that is transverse a longitudinal axis of the first end shank or the second end shank, which hole defines an attachment site. According to certain embodiments, both first end shank and the second end shank have a hole formed therethrough having an axis that is transverse to the longitudinal axis of the respective first end shank or the second end shank, which hole defines the attachment site.

FIG. 4 illustrates an embodiment where the distal end 222 of the end shank 206 is widened relative to the remainder of the end shank 206. According to this embodiment, as illustrated, the first end shank 206 includes a linear bar 264 having a quadrilateral (e.g., rectangular as illustrated, although other shapes such as a square may be possible) cross-section in a plane perpendicular to the longitudinal axis 224. The linear bar 264 has opposing sides 266, 268 of first dimension in a plane perpendicular to the longitudinal axis 262 and opposing ends 270, 272 of second dimension in a plane perpendicular to the longitudinal axis 224. The first dimension is larger than the second dimension. Further, the linear bar 264 has at least one hole 260 extending between the opposing sides 266, 268 of the first end shank 206. In a similar fashion, the embodiment would also have at least one hole extending between similar opposing sides of the second end shank and defining the attachment site.

The shape of the end shank 206 in FIG. 4 is believed to provide a constant (or approximately constant) amount of material in a radial direction. This may be advantageous in addressing the stresses that may be transmitted through the end shank 206 (and in particular, the distal end 222 of the end shank 206).

According to the present disclosure, the attachment sites 204 may be used in challenging environments where water, for example, is present. In such an environment, it may be desirable to apply a layer of elastomeric material to the surfaces that contact. For example, the distal ends 222, 228 of the first and second end shanks 206, 208 may have a layer of elastomeric material applied thereto as a moisture barrier.

As mentioned above, a vibratory apparatus is not limited to the embodiment illustrated in FIG. 1. A series of related embodiments of a vibratory apparatus 400 according to the present disclosure are illustrated in FIGS. 5-8. Here as well, the intent is not to limit the embodiments to the vibratory apparatus 200 illustrated in FIGS. 5-8, which may be referred to as a conveyor, but to illustrate the variation among embodiments of the vibratory apparatus 100, 400 according to the present disclosure.

Turning to FIG. 5, the apparatus 400 includes a deck 402. The deck 402 is part of a trough 404, the trough 404 including side walls 406 that depend upwards from either side of the deck 402. Material may move along the deck 402 from a first end 408 to a second end 410. The apparatus 400 is disposed on a base 412.

The trough 404, and thus the deck 402, may be disposed on the combination of links 414 and resilient members 416. While the resilient members 416 are illustrated in the form of coil springs, other types of resilient members may be used instead (e.g., the spring assembly 200 illustrated in FIGS. 3 and 4). The trough 404 may be coupled to a mechanism for providing reciprocating motion (or exciter), indicated generally at 418, which may include a motor 420 disposed to the side of the trough 404. Such mechanisms may be according to the embodiments illustrated in U.S. Pat. No. 3,750,866, for example, which patent is incorporated by reference herein in its entirety.

In the apparatus 400 according to FIG. 5, it may be desirable to reduce or limit the transmission of forces to the surrounding supports or building. To this end, a counterpoise may be used to absorb or isolate the reaction forces. See FIGS. 6-8. Such a counterpoise may absorb or isolate a significant percentage of the reaction forces. For example, the counterpoise may absorb or isolate up to 95% of the reaction forces. In this regard, see also U.S. Pat. No. 3,750,866, which is incorporated by reference herein in its entirety.

FIG. 6 illustrates a first embodiment of counterpoise 422, such as used in the embodiment of vibratory apparatus 400 illustrated in FIG. 5. The counterpoise 422 includes a frame 424 supported on the base 412 by reactor assemblies 426. Typically, the weight of the counterpoise frame 424 is equal to the weight of the trough 404. The frame 424 is positively driven 180° out of phase with the trough motion (or trough, for short). This results in an equal and opposite dynamic reaction along the rigidly mounted base 412 of the apparatus 400.

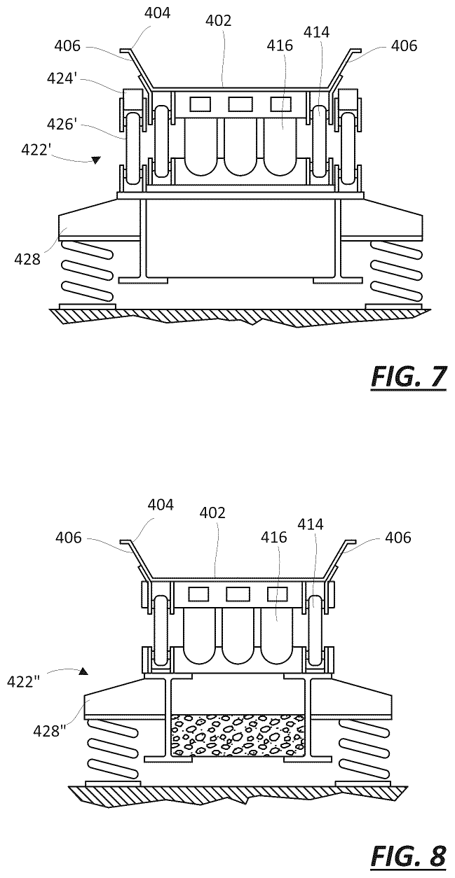

FIG. 7 illustrates a second embodiment of counterpoise that may be used instead of the first embodiment. Parts of this embodiment similar to that of the first embodiment are numbered similarly, with the addition of a prime. The counterpoise 422′ also includes a frame 424′ supported by reactor assemblies 426′. The frame 424′ is also positively 180° out of phase with the trough. Unlike the counterpoise of FIG. 7, the apparatus is mounted on a floating spring-mounted sub-base 428.

FIG. 8 illustrates a third embodiment of counterpoise that may be used instead of the first and second embodiments. Parts of this counterpoise are indicated with a double prime. This embodiment of counterpoise 422″ does not have a frame supported by reactor assemblies. Instead, the remained of the apparatus (trough 404 with deck 402 and sidewalls 406, links 414, and resilient members 416) is mounted on a floating spring-mounted sub-base 428″ counterweighted to provide a highly efficient counterpoise action 180° out of phase with the trough 404.

While three embodiments of counterpoise have been illustrated, other embodiments also exist. For example, two separate and distinct masses, one designed to carry material and the other designed to offset dynamic loads, may be used, with the masses normally running or operated 180° out of phase. As such, the illustrated embodiments are not intended to limit the embodiments of vibratory apparatus possible.

Although the preceding text sets forth a detailed description of different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

What is claimed is:

1. A rocker leg configured for a vibratory apparatus, the rocker leg comprising:
a rocker leg body having a first end and a second end, each of the first end and the second end having a passage therethrough, and
a first bushing and a second bushing, the first bushing disposed in the passage through the first end of the rocker leg body and the second bushing disposed in the passage through the second end of the rocker leg body,
each of the first and second bushings including an inner sleeve, an intermediate ring, and an outer sleeve,
each of the first and second bushings including a first layer of resilient material between the inner sleeve and the intermediate ring, and a second layer of resilient material between the intermediate ring and the outer sleeve.

2. The rocker leg according to claim 1, wherein the inner sleeve, the intermediate ring, and the outer sleeve are annular shaped.

3. The rocker leg according to claim 1, wherein the first layer has a thickness that is equal to the second layer.

4. The rocker leg according to claim 1, wherein the first layer has a thickness that is smaller or larger than a thickness of the second layer.

5. The rocker leg according to claim 1, wherein the resilient material is an elastomer.

6. The rocker leg according to claim 1, wherein the inner sleeve has a passage therethrough configured to accept a fastener.

7. The rocker leg according to claim 1, wherein the rocker leg can accommodate a pivot in excess of ±15 degrees, ±18 degrees, or ±20 degrees from an initial orientation of the rocker leg.

8. A vibratory apparatus comprising:
a deck;
at least one pair of a rocker leg and a resilient member supporting the deck,
the rocker leg including a rocker leg body having a first end and a second end, each of the first end and the second end having a passage therethrough, and a first bushing and a second bushing, the first bushing disposed in the passage through the first end of the rocker leg body and the second bushing disposed in the passage through the second end of the rocker leg body,
each of the first and second bushings including an inner sleeve, an intermediate ring, and an outer sleeve,
each of the first and second bushings including a first layer of resilient material between the inner sleeve and the intermediate ring, and a second layer of resilient material between the intermediate ring and the outer sleeve; and
an eccentric drive coupled to the deck.

9. The vibratory apparatus according to claim 8, wherein the first layer has a thickness that is equal to the second layer.

10. The vibratory apparatus according to claim 8, wherein the first layer has a thickness that is smaller or larger than a thickness of the second layer.

11. The vibratory apparatus according to claim 8, wherein the resilient material is an elastomer.

12. The vibratory apparatus according to claim 8, wherein the resilient member comprises:
a resilient member having a first end shank, a second end shank, and a central helical portion,
the first end shank extending in a first direction from the central helical portion from a proximal end to a distal end, the first end shank having a longitudinal axis from the proximal end to the distal end,
the second end shank extending in a second direction from the central helical portion from a proximal end to a distal end, the second end shank having a longitudinal axis from the proximal end to the distal end, the second direction being opposite the first direction,
the first end shank and the second end shank each comprise a linear bar having a quadrilateral cross-section in a plane perpendicular to the respective longitudinal axis, and
the central helical portion including one or more coils disposed about a central longitudinal axis, the central helical portion having a first end attached to the proximal end of the first end shank and a second end attached to the proximal end of the second end shank,
the longitudinal axis of the first end shank, the longitudinal axis of the second end shank, and the central longitudinal axis of the central helical portion being collinear; and
a transverse attachment site at each of the first end shank and the second end shank configured to receive a fastener.

13. The vibratory apparatus according to claim 12, wherein both of the first end shank and the second end shank have the hole formed therethrough having an axis that is transverse to the longitudinal axis of the respective first end shank or the second end shank and defining the attachment site.

14. The vibratory apparatus according to claim 12, wherein:
the first end shank and the second end shank comprise a linear bar having a rectangular cross-section in a plane perpendicular to the longitudinal axis,
the linear bar having opposing sides of first dimension in a plane perpendicular to the longitudinal axis and opposing ends of second dimension in a plane perpendicular to the longitudinal axis, the first dimension being larger than the second dimension,
the linear bar having at least one hole extending between the opposing sides of the first end shank and at least one hole extending between the opposing sides of the second end shank and defining the attachment site.

15. The vibratory apparatus according to claim 12, wherein the central helical portion comprises a plurality of coils disposed about the central longitudinal axis.

16. The vibratory apparatus according to claim 8, wherein the rocker leg can accommodate a pivot in excess of ±15 degrees, ±18 degrees, or ±20 degrees from an initial orientation of the rocker leg.
